(19) United States
(12) Patent Application Publication
(10) Pub. No.: US 2014/0155509 A1
(43) Pub. Date: Jun. 5, 2014

(54) POLYOL COMPOSITION FOR RIGID POLYURETHANE FOAM AND PRODUCTION METHOD FOR RIGID POLYURETHANE FOAM

(71) Applicants: Tsuguo Watanabe, Osaka-shi (JP); Jun Akai, Osaka-shi (JP)

(72) Inventors: Tsuguo Watanabe, Osaka-shi (JP); Jun Akai, Osaka-shi (JP)

(73) Assignee: TOYO TIRE & RUBBER CO., LTD., Osaka-shi, Osaka (JP)

(21) Appl. No.: 14/131,863

(22) PCT Filed: Jun. 12, 2012
(86) PCT No.: PCT/JP2012/064979

§ 371 Date: Jan. 9, 2014

(30) Foreign Application Priority Data
Jul. 14, 2011 (JP) 2011-155814
Feb. 2, 2012 (JP) 2012-021043

(51) Int. Cl. C08G 18/66

(52) U.S. Cl. CPC C08G 18/66
USPC 521/174

(57) ABSTRACT

A polyol composition for a rigid polyurethane foam, which comprises polyol compounds, and water as a blowing agent, and which is mixed with a polyisocyanate component to react therewith, and thereby forming the rigid polyurethane foam, wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250, and the water is contained in an amount of 20 to 100 parts by weight for 100 parts by weight of the polyol compounds.

### TECHNICAL FIELD

The present invention relates to a polyol composition, for a rigid polyurethane foam, containing water as a blowing agent, and a production method for a rigid polyurethane foam having a low density and an excellent heat insulating performance.

### BACKGROUND ART

Hitherto, glass wool has widely been used as heat insulating material for detached houses and other buildings. Glass wool is not necessarily sufficient in heat insulating performance, but is inexpensive. This would be a reason why glass wool is widely used. On the other hand, rigid polyurethane foam is better in heat insulating performance than glass wool. However, the foam is expensive and therefore not as widely used as glass wool is.

It is conceivable for lowering the price of rigid polyurethane foam that the foam is lowered in density while the heat insulating performance thereof is being maintained. Patent Document 1 listed below states that a low-density rigid polyurethane foam having a core density of 2 to 20 kg/m³ both inclusive is produced in a spraying manner using, as a raw material, a polyol composition comprising a polyoxyalkylene polyether polyol having a number-average molecular weight of 2000 to 9000, and a polyoxyalkylene polyether polyol having a number-average molecular weight of 250 to 750. However, when the polyol composition described in this document is used as the raw material, a limitation is imposed in lowering the density of the foam, considering cell roughness (poorness in the appearance of the foam), brittleness (fragileness of the foam), and others. The rigid polyurethane foam described in this document is conceived to be used for being sprayed; thus, it is important for the foam to have a low recovery percentage. Thus, the foam is poor in flexibility.

Patent Document 2 listed below states that a low-density rigid polyurethane foam having a core density of 5 to 14 kg/m³ both inclusive is produced by continuous slab foaming using, as raw materials, a polyether polyol having an average functional group number of 2.5 to 4 and a hydroxyl value of 200 to 300 mgKOH/g, a polyether polyol having an average functional group number of 4 to 6 and a hydroxyl value of 400 to 900 mgKOH/g, a polyether polyol having an average functional group number of 2.5 to 3.5 and a hydroxyl value of 20 to 60 mgKOH/g, and a polyol composition. However, about the rigid polyurethane foam described in this document also, a limitation is imposed in lowering the density of the foam, considering cell roughness (poorness in the appearance of the foam), brittleness (fragileness of the foam), and others.

Patent Document 3 listed below describes a method for producing an interconnected-cell rigid polyurethane foam, using a mixture of (a) a polyoxyalkylene polyol having 2 to 3.5 functional groups, a hydroxyl value of 28 to 90 mgKOH/g, and a polyoxyethylene unit content by percentage of 5% or less by weight, (b) a polyoxyalkylene polyol having 3 to 6 functional groups and a hydroxyl value of 150 to 500 mgKOH/g and (c) a polyol having 2 to 3 functional groups and a hydroxyl value of 450 to 840 mgKOH/g, and water as a blowing agent in an amount of 6 to 12 parts by weight for 100 parts by weight of the mixture of the polyols. However, in this production method, the lower limit of the density of the foam is specified from the viewpoint of the strength of the foam. Thus, a limitation is imposed in lowering the density of the foam.

### PRIOR ART DOCUMENTS

### Patent Documents

Patent Document 1: JP-A-2002-293868
Patent Document 2: Japanese Patent No. 4079254
Patent Document 3: JP-A-06-25375

### SUMMARY OF THE INVENTION

### Problems to be Solved by the Invention

In light of the above-mentioned actual situation, the present invention has been made, and an object thereof is to provide a polyol composition, for rigid polyurethane foam, that has a low density and an excellent heat insulating performance, and serves as a raw material for producing a rigid polyurethane foam useful as a heat insulating material for detached houses and other buildings; and a production method for the rigid polyurethane foam.

### Means for Solving the Problems

This object can be attained by the present invention, which is an invention as described below. The present invention is a polyol composition for a rigid polyurethane foam, which comprises polyol compounds, and water as a blowing agent, and which is mixed with a polyisocyanate component to react therewith, and thereby forming the rigid polyurethane foam, wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250, and the water is contained in an amount of 20 to 100 parts by weight for 100 parts by weight of the polyol compounds.

The polyol composition, for a rigid polyurethane foam, contains 20 to 100 parts by weight of water as a blowing agent. Thus, when this polyol composition is used as a raw material, a low-density rigid polyurethane foam can be produced.

Incidentally, in the case of a polyol composition containing only a polyether polyol having a high molecular weight as a polyol compound, the resin is insufficient in strength at the blowing stage into a foam by increasing the blend proportion of water in the polyol composition. Thus, blowing gas inside the foam is released off in a large quantity so that the foam is easily shrunken. As a result, the density of the foam tends to be insufficiently lowered. However, the polyol composition (of the present invention) for a rigid polyurethane foam contains the short glycol (B), the molecular weight of which is less than 250, together with the high-molecular-weight polyether polyol (A); thus, at the initial blowing stage into a foam, the composition is increased in viscosity-increasing rate (resinification rate). According to this increase, the foam is heightened in recovery percentage by effect of the high-molecular-weight polyether polyol (A) and further the foam is heightened in resin strength from the initial blowing stage into the foam by effect of the low-molecular-weight short glycol (B). As a result, a rigid polyurethane foam low in density and excellent in flexibility can be produced.

Furthermore, the foam has a small cell diameter even when made low in density because the polyol composition contains the high-molecular-weight polyether polyol (A) and the low-molecular-weight short glycol (B). As a result, the foam can be prevented from undergoing cell roughness (poorness in the appearance of the foam) and further restrained from becoming fragile to be made low in brittleness.

In the polyol composition for a rigid polyurethane foam, it is preferred that the polyether polyol (A) is contained in an amount of 10 to 80 parts by weight for 100 parts by weight of the polyol compounds, and the short glycol (B) is contained in an amount of 10 to 60 parts by weight therefor. This embodiment makes it possible to heighten the foam in recovery percentage and make the foam small in cell diameter while raising the foam in resin strength. As a result, the rigid polyurethane foam can be improved in brittleness and flexibility with a better balance while lowered in density.

In the polyol composition for a rigid polyurethane foam, it is preferred that the polyol compounds further comprise a polyether polyol (C) which is a polymer made from propylene oxide and has an average functional group number of 2 to 4 and a weight-average molecular weight of 3000 to 5000. In a case where the composition comprises, as one of the polyol compounds, the high-molecular-weight polyether polyol (C), which is a polymer made from propylene oxide, cell membranes of the foam are broken at the late blowing stage into the foam so that the foam turns easily to an interconnected-cell rigid polyurethane foam. As a result, the foam can be lowered in density with a higher certainty while restrained in foam shrinkage and other damages.

The production method for a rigid polyurethane foam according to the present invention is a method of mixing a polyol composition comprising polyol compounds and water as a blowing agent with a polyisocyanate component and causing the composition to react therewith to form the rigid polyurethane foam, wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250, and the water is contained in an amount of 20 to 100 parts by weight for 100 parts by weight of the polyol compounds.

In the production method for a rigid polyurethane foam, it is preferred that the polyether polyol (A) is contained in an amount of 10 to 80 parts by weight for 100 parts by weight of the polyol compounds, and the short glycol (B) is contained in an amount of 10 to 60 parts by weight therefor.

In the production method for a rigid polyurethane foam, it is preferred that the polyol compounds further comprise a polyether polyol (C) which is a polymer made from propylene oxide and has an average functional group number of 2 to 4 and a weight-average molecular weight of 3000 to 5000.

### MODE FOR CARRYING OUT THE INVENTION

The polyol composition for a rigid polyurethane foam according to the present invention contains, as its polyol compounds, a polyether polyol (A) which is a polymer made from an alkylene oxide and has an average functional group number of 2 to 4 and a weight-average molecular weight of 3000 to 8000, and a short glycol (B) having a molecular weight less than 250.

The polyether polyol (A) is a polyoxyalkylene polyol obtained by causing an alkylene oxide to ring-opening-addition polymerize with an initiator having 2 to 4 active hydrogen atoms. Specific examples of the initiator include aliphatic polyhydric alcohols (for example, glycols such as ethylene glycol, propylene glycol, diethylene glycol, dipropylene glycol, 1,4-butanediol, 1,3-butanediol, 1,6-hexanediol, neopentyl glycol, cyclohexylene glycol, cyclohexanedimethanol and the like, triols such as trimethylolpropane, glycerin and the like, and tetra-functional alcohols such as pentaerythritol and the like; aliphatic amines (for example, alkylenediamines such as ethylenediamine, propylenediamine, butylenediamine, hexamethylenediamine, neopentyldiamine and the like, and alkanolamines such as monoethanolamine, diethanolamine and the like); aromatic amines (for example, 2,4-toluenediamine, 2,6-toluenediamine, diethyltoluenediamine, 4,4′-diaminodiphenylmethane, p-phenylenediamine, o-phenylenediamine, naphthalenediamine and the like). These may be used alone or in any combination of two or more thereof. The initiator to be used is preferably aliphatic alcohols, more preferably triols, particularly preferably glycerin. The average functional group number of the polyether polyol (A) is 2 to 4, more preferably 2.5 to 3.5. Further, the weight-average molecular weight of the polyether polyol (A) is more preferably 3000 to 5000.

Examples of the alkylene oxide include ethylene oxide, propylene oxide, 1,2-butylene oxide, 2,3-butylene oxide, styrene oxide, cyclohexene oxide and the like. It is preferred to use ethylene oxide and propylene oxide, out of these examples, together to ring-opening-addition polymerize with the initiator. At this time, it is preferred to set the proportion of ethylene oxide (the proportion “ethylene oxide”/“ethylene oxide+propylene oxide”) into the range of 5 to 30%.

The hydroxyl value of the polyether polyol (A) is preferably 20 to 100 mgKOH/g, more preferably 30 to 60 mgKOH/g. If the hydroxyl value is less than 20 mgKOH/g, the ratio of the viscosity of the polyol composition to that of the polyisocyanate component is high so that these are insufficiently stirred at the time of the mixing. Contrarily, if the value is more than 100 mgKOH/g, it is difficult that the resultant polyurethane foam gains an appropriate toughness. The hydroxyl value is a value measured in accordance with JIS K1557-1:2007.

Examples of the short glycol (B), the molecular weight of which is less than 250, include ethylene glycol (molecular weight: 62), propylene glycol (molecular weight: 76), diethylene glycol (molecular weight: 106), dipropylene glycol (molecular weight: 134), 1,4-butanediol (molecular weight: 90), 1,3-butanediol (molecular weight: 90), 1,6-hexanediol (molecular weight: 118), glycerin (molecular weight: 92), tripropylene glycol (molecular weight: 192) and the like. Of these examples, diethylene glycol, dipropylene glycol and glycerin are preferred and diethylene glycol is particularly preferred in order to heighten the resin strength of the foam with a higher certainty. The molecular weight of the short glycol (B) is preferably from 62 to 200, more preferably from 90 to 150.

It is preferred that the polyol composition for a rigid polyurethane foam according to the present invention further contains, as one of the polyol compounds, a polyether polyol (C) which is a polymer made from propylene oxide and has an average functional group number of 2 to 4 and a weight-average molecular weight of 3000 to 5000. The polyether polyol (C) is a polyoxyalkylene polyol obtained by causing only propylene oxide to ring-opening-addition polymerize with an initiator having 2 to 4 active hydrogen atoms. The initiator is not particularly limited, and examples thereof include above-mentioned aliphatic polyhydric alcohols, aliphatic amines, and aromatic amines. The initiator is particularly preferably glycerin.

In order to produce a rigid polyurethane foam which gives an excellent heat insulating performance while lowered in density, the polyol composition for a rigid polyurethane foam according to the present invention preferably contains the polyether polyol (A) in an amount of 10 to 80 parts by weight for 100 parts by weight of the polyol compounds, and the short glycol (B) in an amount of 10 to 60 parts by weight therefor, and more preferably contains the polyether polyol (A) in an amount of 15 to 70 parts by weight therefor and the short glycol (B) in an amount of 10 to 50 parts by weight therefor. When the composition contains the polyether polyol (C), the composition preferably contains the polyether polyol (A), the short glycol (B), and the polyether polyol (C) in respective amounts of 10 to 30 parts by weight, 10 to 60 parts by weight and 30 to 70 parts by weight therefor, and more preferably contains the components (A), (B) and (C) in respective amounts of 15 to 25 parts by weight, 10 to 50 parts by weight and 40 to 60 parts by weight therefor.

Water is blended as a blowing agent into the polyol composition for a rigid polyurethane foam according to the present invention. The blowing agent is preferably water alone. The blend amount thereof is 20 to 100 parts by weight, more preferably 30 to 90 parts by weight, even more preferably 40 to 80 parts by weight for 100 parts by weight of the polyol compounds. The blend of water in such a large amount makes it possible to lower the density of the polyurethane foam.

Usually, a flame retardant, a catalyst and a foam stabilizer are further blended into the polyol composition according to the present invention. Various additives may further be blended thereinto which are blendable into any polyol composition for a rigid polyurethane foam. Examples thereof include a colorant and an antioxidant.

Examples of the flame retardant include organic phosphates, halogen-containing compounds, and metal compounds such as aluminum hydroxide. Organic phosphates are particularly preferred since these compounds have an effect of lowering the viscosity of the polyol composition. Examples of the organic phosphates include halogenated alkyl esters of phosphoric acid, alkyl phosphates, aryl phosphates, and phosphonates. Specific examples thereof include tris (chloropropyl) phosphate (TMCPP, manufactured by Daihachi Chemical Industry Co., Ltd.), tributoxyethyl phosphate (TBEP), tributyl phosphate, triethyl phosphate, trimethyl phosphate, and cresylphenyl phosphate. The blend amount of the flame retardant is preferably 10 to 50 parts by weight, more preferably 15 to 40 parts by weight for 100 parts by weight of the polyol compounds. It is particularly preferred that the polyol composition contains, besides the polyether polyol (A) and the short glycol (B), the flame retardant in an amount of 20 parts or more by weight for 100 parts by weight of the polyol compounds since the foam can be prevented from being worse in brittleness.

The catalyst is not particularly limited as far as the catalyst promotes the urethanating reaction. The catalyst is preferably a reactive amine catalyst which can react with isocyanate groups of the polyisocyanate component. Examples of such an reactive amine catalyst include N,N-dimethylethanolamine, N,N-dimethylaminoethoxyethanol, N,N,N′-trimethylaminoethylethanolamine, N,N,N′,N′-tetramethyl-2-hydroxypropylenediamine, N-hydroxyethylmorpholine, N-methyl-N-hydroxyethylpiperazine, N,N-dimethylpropylenediamine and the like.

An ordinary tertiary amine catalyst is also usable. Examples of the tertiary amine catalyst include N,N,N′,N′-tetramethylethylenedimaine, N,N,N′,N′-tetramethylhexamethylenediamine, N,N,N′,N′,N″-pentamethyldiethylenetriamine, diazabicycloundecene, N,N-dimethylcyclohexylamine, triethylenediamine, N-methylmorpholine and the like.

The blend amount of the catalyst is preferably 2 to 10 parts by weight, more preferably 3 to 8 parts by weight for 100 parts by weight of the polyol compounds.

The foam stabilizer may be, out of known foam stabilizers for rigid polyurethane foams, for example, a graft copolymer of a polyoxyalkylene glycol, which is a polymer made from ethylene oxide or propylene oxide, and polydimethylsiloxane. The foam stabilizer is preferably a silicone foam stabilizer wherein the oxyethylene group content by percentage in a polyoxyalkylene is 70 to 100% by mole. Specific examples thereof include products SH-193, SZ-1671, SF-2937F, and SF-2938F (manufactured by Dow Corning Toray Co., Ltd.); products B-8465, B-8467 and B-8481 (manufactured by Evonik Degussa Japan Co., Ltd.); a product L-6900 (manufactured by Momentive) and the like. The blend amount of the foam stabilizer is preferably 1 to 10 parts by weight for 100 parts by weight of the polyol compounds.

The polyisocyanate component, which is mixed with the polyol composition to react with each other to form a rigid polyurethane foam, may be various types of polyisocyanate compounds having two or more isocyanate groups, such as aromatic types, alicyclic types, aliphatic types and the like. The polyisocyanate component is preferably diphenylmethane diisocyanate (MDI) in a liquid form since the component is easy to handle, is fast in reaction rate, gives a polyurethane foam excellent in physical properties, is low in costs, and provides other advantages. Examples of liquid-form MDI include crude MDIs (c-MDIs) (such as products 44V-10 and 44V-20 (manufactured by Sumika Bayer Urethane Co., Ltd.), a product MILLIONATE MR-200 (Nippon Polyurethane Industry Co., Ltd.), and urethonimine-containing MDI (a product, MILLIONATE MTL, manufactured by Nippon Polyurethane Industry Co., Ltd.). Together with liquid-form MDI, a different polyisocyanate compound may be used. The polyisocyanate compound used together may be any known polyisocyanate compound in the technical field of polyurethane.

The production method for a rigid polyurethane foam according to the present invention is a method of mixing a polyol composition comprising polyol compounds and water as a blowing agent with a polyisocyanate component to react with each other, thereby forming the rigid polyurethane foam, wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250, and the water is contained in an amount of 20 to 100 parts by weight for 100 parts by weight of the polyol compounds. In this production method, it is preferred that the polyether polyol (A) is contained in an amount of 10 to 80 parts by weight for 100 parts by weight of the polyol compounds, and the short glycol (B) is contained in an amount of 10 to 60 parts by weight therefor. It is more preferred that the polyol compounds further comprise a polyether polyol (C) which is a polymer made from propylene oxide and has an average functional group number of 2 to 4 and a weight-average molecular weight of 3000 to 5000.

In the production method, at the time of mixing the polyol composition and the polyisocyanate component to react with each other, the isocyanate index (NCO index) is preferably 30 to 100, more preferably 40 to 70. By setting the isocyanate index within the range, the foam can be prevented from being worse in brittleness even when made low in density. The isocyanate index denotes, on percentage, the proportion by equivalent of isocyanate groups of the polyisocyanate components to all active hydrogen groups (about water as a blowing agent, a calculation is made on the supposition that water is a bifunctional active hydrogen compound) contained in the polyol composition (the ratio of the equivalents of the isocyanate groups to 100 equivalents of the active hydrogen groups).

The density of the rigid polyurethane foam obtained by this production method is preferably 20 kg/m³ or less, more preferably 15 kg/m³ or less, even more preferably 10 kg/m³ or less. This foam density can be set within the range, for example, by adjusting the amount of water as a blowing agent within the range of 20 to 100 parts by weight (for 100 parts by weight of the polyol compounds). The foam density is a value measured according to JIS K7222.

The closed-cell proportion of the rigid polyurethane foam obtained by this production method is preferably 15% or less, more preferably 0 to 10%. By making the interconnected-cell proportion high as above, the rigid polyurethane foam can ensure an excellent dimension stability. The closed-cell proportion is a value measured according to ASTM D2856.

About the rigid polyurethane foam obtained by this production method, the thermal conductivity λ preferably satisfies the following: λ≦0.04 W/m·K. In this case, the rigid polyurethane foam can exhibit a sufficient heat insulating performance even when the foam has been lowered in density. The thermal conductivity is a value measured according to JIS A1412-2.

In the production method for a rigid polyurethane foam, the foam may be continuously produced in a continuous line, or may be produced in a batch manner. The manner of the production is not particularly limited, and examples thereof include a spraying manner of spraying the foam onto a constituent substrate of a building, and an injection manner of injecting a mixture of the polyol composition and the polyisocyanate component into voids made by building substrates.

### EXAMPLES

Hereinafter, the present invention will be described in more detail by way of examples. However, the present invention is not limited to these examples.

### (Preparation of Polyol Compositions)

Polyol compositions were each prepared in accordance with a blend composition described in Table 1. Details of individual components in Table 1 are as follows:

(1) Polyol compounds

Polyether polyol (A)-1: trade name “EXCENOL-820” (manufactured by Asahi Glass Co., Ltd.), which is a polyether polyol (weight-average molecular weight=4900, and hydroxyl value (OHV)=34 mgKOH/g) obtained by using glycerin as an initiator and addition-polymerizing ethylene oxide and propylene oxide thereto.

Polyether polyol (A)-2: trade name “EXCENOL-230” (manufactured by Asahi Glass Co., Ltd.), which is a polyether polyol (weight-average molecular weight=3000, and hydroxyl value (OHV)=56 mgKOH/g) obtained by using glycerin as an initiator and addition-polymerizing ethylene oxide and propylene oxide thereto.

Polyether polyol (A)-3: trade name “EXCENOL-851” (manufactured by Asahi Glass Co., Ltd.), which is a polyether polyol (weight-average molecular weight=7000, and hydroxyl value (OHV)=25 mgKOH/g) obtained by using glycerin as an initiator and addition-polymerizing ethylene oxide and propylene oxide thereto.

Short glycol (B)-1: diethylene glycol (DEG) (molecular weight=106, and hydroxyl value (OHV)=1058 mgKOH/g, manufactured by Nacalai Tesque, Inc.)

Short glycol (B)-2: glycerin (Gly) (molecular weight=92, and hydroxyl value (OHV)=1829 mgKOH/g, manufactured by Nacalai Tesque, Inc.)

Polyether polyol (C): trade name “T-3000S” (manufactured by Mitsui Chemicals, Inc.), which is a polyether polyol (weight-average molecular weight=3000, and hydroxyl value=56 mgKOH/g) obtained by using glycerin as an initiator and addition-polymerizing only propylene oxide thereto.

(2) Flame retardant: trade name “TMCPP” (manufactured by Daihachi Chemical Industry Co., Ltd.)

(3) Foam stabilizer: silicone type nonionic surfactant, trade name “SF-2938F” (manufactured by Dow Corning Toray Co., Ltd.)

(4) Catalysts

Catalyst-1: tertiary amine catalyst, trade name “TOYOCAT-ET” (manufactured by Tosoh Corporation)

Catalyst-2: N,N-dimethylaminoethoxyethanol, trade name “KAO No. 26” (manufactured by Kao Corporation)

### (Laboratory Evaluation)

In accordance with a usual method, each of the prepared polyol compositions (Examples 1 to 6, and Comparative Example 1) was mixed with a polyisocyanate component to react with each other to produce a rigid polyurethane foam. The polyisocyanate component used was c-MDI (“Sumidur 44V-10” manufactured by Sumika Bayer Urethane Co., Ltd.; NCO %: 31%). The isocyanate index (NCO Index) thereof was as described in Table 1. The following evaluations were made, and the results are shown in Table 1.

### [Weight-Average Molecular Weight]

The foam was measured about the weight-average molecular weight thereof, using GPC (gel permeation chromatography), to give a value in terms of standard polystyrene.

GPC instrument: LC-10A, manufactured by Shimadzu Corporation

Columns: the following three columns were connected to each other, and the resultant was used: “PLgel, 5 μm, 500 Å”, “PLgel, 5 μm, 100 Å” and “PLgel, 5 μm, 50 Å”, manufactured by Polymer Laboratories Ltd.

Flow rate: 1.0 mL/min

Concentration: 1.0 g/L

Injection volume: 40 μL

Column temperature: 40° C.

Eluent: tetrahydrofuran

### [Foam Density]

The foam density was analyzed according to JIS K 7222.

### [Thermal Conductivity]

The thermal conductivity was measured according to JIS A1412-2 (Method for Measuring Thermal Resistance and Thermal Conductivity of Thermal Insulating Material; Section 2: Heat Flow Meter Method) (HFM method) on the basis of JIS A9526 (Sprayed Rigid Polyurethane Foam for Building-Heat-Insulation).

### [Foam Appearance]

About the produced rigid polyurethane foam, the appearance of its core region was evaluated with the naked eye. When the foam was fine in cell diameter, particularly good in foamed state and very low in brittleness, the foam was judged to be good (circular sign: ◯). When the foam was coarse in cell diameter, bad in foamed state and high in brittleness, the foam was judged to be bad (cross sign: X).

TABLE 1

| | OHV | | | | | | | Comparative |
|---|---|---|---|---|---|---|---|---|
| Blend agents | (mgKOH/g) | Example 1 | Example 2 | Example 3 | Example 4 | Example 5 | Example 6 | Example 1 |
| Polyether polyol (A)-1 | 34 | 60 | 20 | — | — | 30 | — | 20 |
| Polyether polyol (A)-2 | 56 | — | — | 20 | 20 | — | — | — |
| Polyether polyol (A)-3 | 25 | — | — | — | — | — | 30 | — |
| Polyether polyol (C) | 56 | — | 70 | 50 | 60 | 40 | 40 | 80 |
| Short glycol (B)-1 (DEG) | 1058 | 40 | 10 | — | 20 | 30 | 30 | — |
| Short glycol (B)-2 (Gly) | 1829 | — | — | 30 | — | — | — | — |
| Flame retardant | | 30 | 30 | 30 | 30 | 30 | 30 | 30 |
| Foam stabilizer-1 | | 5.0 | 5.0 | 5.0 | 5.0 | 5.0 | 5.0 | 5.0 |
| Catalyst-1 | | 4.0 | 4.0 | 4.0 | 4.0 | 4.0 | 4.0 | 4.0 |
| Catalyst-2 | | 2.0 | 2.0 | 2.0 | 2.0 | 2.0 | 2.0 | 2.0 |
| Water | | 80.0 | 60.0 | 40.0 | 60.0 | 40.0 | 40.0 | 40.0 |
| Polyisocyanate | (NCO %) | (31%) | (31%) | (31%) | (31%) | (31%) | (31%) | (31%) |
| component | (NCO INDEX) | 37 | 50 | 57 | 50 | 63 | 63 | 69 |

| | | | | | | | |
|---|---|---|---|---|---|---|---|
| Foam density (kg/m³) | 5.7 | 7.4 | 7.6 | 6.9 | 7.3 | 7.5 | 9.8 |
| Thermal conductivity (mW/m · K) | 39.0 | 38.1 | 37.5 | 38.5 | 38.9 | 39.1 | 41.8 |
| Foamed state | ∘ | ∘ | ∘ | ∘ | ∘ | ∘ | x |

From the results in Table 1, it is understood that the rigid polyurethane foams produced from the polyol compositions according to Examples 1 to 6 as raw materials were low in density, low in brittleness and excellent in heat insulating performance. By contrast, about the rigid polyurethane foam produced from the polyol composition according to Comparative Example 1 as a raw material, blowing gas inside the foam was released off in a large quantity. Furthermore, cell roughness was generated and the brittleness was high.

Next, a foam sample of 5-cm square was prepared from the rigid polyurethane foam produced from the polyol composition according to Example 1 as a raw material. This was compressed (by 10%) into a 90%-shape in the T direction (parallel to the foamed direction of foam cells) and in the W direction (perpendicular to the foamed direction of foam cells). The recovery percentage thereof was then measured. As a result, the foam was recovered into a 99.0%-shape in the T direction while recovered into a 98.2%-shape in the W direction. It is therefore understood that the rigid polyurethane foam according to the present invention is high in recovery percentage to be excellent in flexibility.

1. A polyol composition for a rigid polyurethane foam, which comprises polyol compounds, and water as a blowing agent, and which is mixed with a polyisocyanate component to react therewith, and thereby forming the rigid polyurethane foam,
wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250, and
the water is contained in an amount of 20 to 100 parts by weight for 100 parts by weight of the polyol compounds.

2. The polyol composition for a rigid polyurethane foam according to claim 1, wherein the polyether polyol (A) is contained in an amount of 10 to 80 parts by weight for 100 parts by weight of the polyol compounds, and the short glycol (B) is contained in an amount of 10 to 60 parts by weight therefor.

3. The polyol composition for a rigid polyurethane foam according to claim 1, wherein the polyol compounds further comprise a polyether polyol (C) which is a polymer made from propylene oxide and has an average functional group number of 2 to 4 and a weight-average molecular weight of 3000 to 5000.

4. A production method for a rigid polyurethane foam, which is a method of mixing a polyol composition comprising polyol compounds and water as a blowing agent with a polyisocyanate component to react with each other, thereby forming the rigid polyurethane foam,
wherein the polyol compounds comprise a polyether polyol (A) which is a polymer made from ethylene oxide and propylene oxide and has an average functional group number of 2 to 4 and a weight-average molecular weight of 3000 to 8000, and a short glycol (B) having a molecular weight less than 250, and
the water is contained in an amount of 20 to 100 parts by weight for 100 parts by weight of the polyol compounds.

5. The production method for a rigid polyurethane foam according to claim 4, wherein the polyether polyol (A) is contained in an amount of 10 to 80 parts by weight for 100 parts by weight of the polyol compounds, and the short glycol (B) is contained in an amount of 10 to 60 parts by weight therefor.

6. The production method for a rigid polyurethane foam according to claim 4, wherein the polyol compounds further comprise a polyether polyol (C) which is a polymer made from propylene oxide and has an average functional group number of 2 to 4 and a weight-average molecular weight of 3000 to 5000.
